(19) United States
(12) Patent Application Publication
(10) Pub. No.: US 2005/0143055 A1
(43) Pub. Date: Jun. 30, 2005

(54) Wireless caller ID display for the hearing-impaired

(76) Inventor: Richard H. Hinkson, Plainview, NY (US)

Correspondence Address: HONEYWELL INTERNATIONAL, INC.;LAW DEPARTMENT, 101 COLUMBIA ROAD, MORRISTOWN, NJ, 07692, US

(21) Appl. No.: 10/750,086

(22) Filed: Dec. 31, 2003

(51) Int. Cl. H04M 3/42

(52) U.S. Cl. 455/415; 455/422.1; 455/426.1

(57) ABSTRACT

A system and method to assist the user of a wired phone that includes a security panel that includes means for connection to an associated phone line, a caller ID receiver and an RF transmitter. The caller ID receiver cooperates with the associated phone line and the RF transmitter cooperates with the caller ID receiver to transmit caller ID information. The system further includes a bracelet to be worn by an associated user that includes an RF receiver. The RF receiver cooperates with the RF transmitter to access information provided by the RF transmitter. The bracelet further includes a display cooperating with the RF receiver to indicate to the user information regarding an incoming call on the associated phone line.

### BACKGROUND OF THE INVENTION

The invention relates to safety and security apparatus and methods and particularly to apparatus and methods for assisting hearing impaired people. Many hearing-impaired people have difficulty hearing a telephone. In addition, many hearing-impaired people are also elderly and not able to reach a phone quickly. The person may be put at an even greater than normal risk of injury by rushing to answer a call which may be unimportant. Those skilled in the art will recognize that the apparatus also has application to noisy environments such as night clubs and noisy factory floors.

Caller ID is a feature available over the public switched telephone network whereby an incoming call's telephone number is automatically made available to the called party. This feature has become very useful for both businesses and homes, enabling the receiver of an incoming call to know the phone number of the phone being used by the calling party before answering the incoming call.

### SUMMARY OF THE INVENTION

It is an object of the invention to provide a wireless apparatus suitable for a user to wear or carry that would provide information concerning an incoming phone call on an associated conventional telephone handset.

Another object of the invention is to provide such an apparatus that will include structure for generating a vibration to alert the user of an incoming phone call.

Still another object of the invention is to provide such apparatus that will have a display of the caller's phone number, caller's name, and additional text.

Yet another object the invention is to provide a wireless apparatus that will also allow the user to a) Answer the call and put out a message indicating that he or she is on the way to the phone, b) Answer the call and activate a speakerphone function allowing hands-free communication, or c) Trigger an emergency message from the control panel.

It has now been found that these and other objects of the invention may be attained in a system to assist the user of a wired phone which includes apparatus for connection to an associated phone line, a caller ID receiver and an RF transmitter. The caller ID receiver cooperates with the associated phone line and the RF transmitter cooperates with the caller ID receiver to transmit caller ID information. The system further includes a bracelet to be worn by an associated user that includes an RF receiver. The RF receiver cooperates with the RF transmitter to access information provided by the RF transmitter. The bracelet further includes a display cooperating with the RF receiver to indicate to the user information regarding an incoming call on the associated phone line.

In some forms of the invention the RF transmitter is a transceiver and the RF transmitter and the RF receiver is also a transceiver. The bracelet may include a vibrating alert cooperating with the RF receiver to produce a vibration stimulus when the RF receiver receives a signal from the RF transmitter. In addition the security panel may include an audio amplifier and a speaker coupled to the audio amplifier. In some cases the apparatus includes a microprocessor that may be utilized to format messages to the RF transceiver.

The bracelet may further include at least one pushbutton cooperating with the RF transceiver in the bracelet to produce a predetermined output from the RF transceiver in the bracelet and the output of the RF transceiver in the bracelet cooperates with the RF transceiver in the security panel to produce a predetermined output to the microprocessor. The predetermined output to the microprocessor may cause the associated phone line to go off hook and in some cases to deliver a predetermined message to be delivered to an individual placing an incoming call.

The security panel may include an audio amplifier and the predetermined output may cause the activation of the audio amplifier. And additional pushbutton in the bracelet may cooperate with the RF transceiver in the bracelet to produce a second predetermined output from the RF transceiver in the bracelet, the output of the RF transceiver in the bracelet may cooperate with the RF transceiver in the security panel to produce a second predetermined output to the microprocessor. The second predetermined output to the microprocessor may initiate a message to an incoming caller that the user will answer the call shortly.

The caller ID receiver may include a caller ID receiver chip. The microprocessor may format a predetermined voice message that is audible to a caller making an incoming call to the security panel. The voice message may be a message that the end-user of the system needs additional time to reach the phone.

The method to assist the user of a wired phone includes connecting to an associated phone line, providing apparatus that includes a caller ID receiver and an RF transmitter, and the providing step includes providing apparatus with a caller ID receiver. The method also includes coupling the associated phone line to an RF transmitter and a caller ID receiver to transmit caller ID information. The method further includes the step of providing a bracelet to be worn by an associated user that includes an RF receiver, the step of providing an RF receiver cooperating with the RF transmitter to access information provided by the RF transmitter, a display cooperating with the RF receiver to indicate to the user information regarding an incoming call on the associated phone line.

The method may further include the step of providing a transceiver. In some cases the method of providing an RF transmitter and an RF receiver includes providing first and second RF transceivers. The method may further include the step producing a vibration stimulus when the RF receiver receives a signal from the RF transmitter. The providing step may further includes providing an audio amplifier in some cases providing a speaker coupled to said audio amplifier and/or a microprocessor.

### BRIEF DESCRIPTION OF THE DRAWING

The invention will be better understood by reference to the accompanying drawing in which:

FIG. 1 is a schematic view of the portion of one form of the apparatus intended to be attached to a conventional telephone line.

FIG. 2 is a schematic view of one form of the portion of the apparatus intended to be worn or carry by a user.

### DESCRIPTION OF THE PREFERRED EMBODIMENT

In the following description, numerous technical details are set forth such as specific hardware interfaces, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. Some details have been omitted inasmuch as such details are not necessary to obtain a complete understanding of the present invention and are within the skills of persons of ordinary skill in the relevant art.

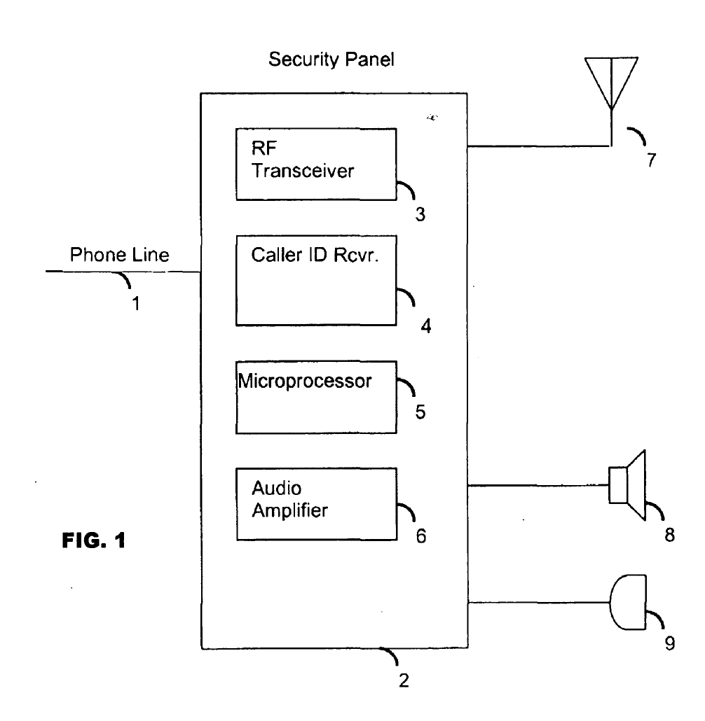

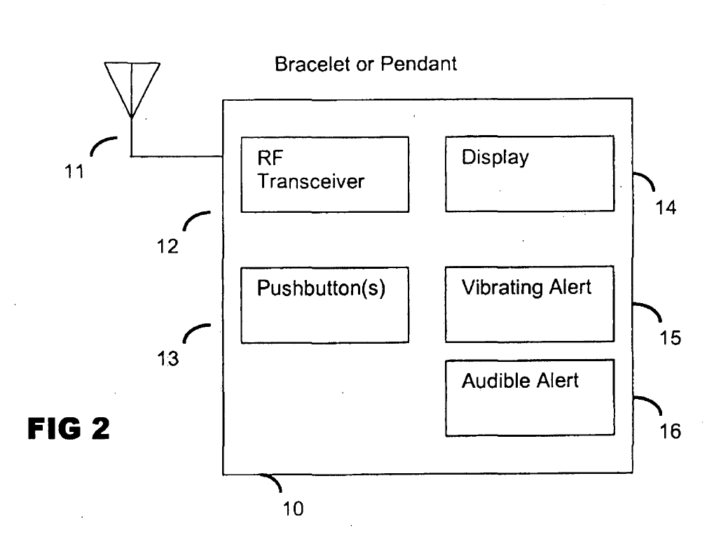

Referring now to FIGS. 1 and 2 there is shown one form of the apparatus in accordance with the present invention. There are two portions of this form of the apparatus. The first portion is a security control panel 2, shown in FIG. 1, attached to a telephone line 1. The security control panel 2 is comprised of an RF transceiver 3, a caller ID receiver 4, a microprocessor 5 and an audio amplifier 6. The RF transceiver 3 is connected to antenna 7. The audio amplifier is attached to a speaker 8 and a microphone 9. The microprocessor and associated memory 5 may include any general purpose device such as an Intel 8051 microprocessor. The microprocessor and associated memory 5 is used to monitor the various parts of the system and make decisions based upon the state of the inputs. In addition, the microprocessor and associated memory 5 may be used to control the audio amplifier and format messages to the RF transceiver 3 in the system and method in accordance with the present invention. The security control panel 2 also includes a caller ID receiver 4 that is built up from discrete components or utilizes a caller ID receiver chip such as a Mitel Calling Number Identification Circuit MT8843 or similar device. The system and method may include software that is commercially available or within the skill of practitioners in the programming arts.

The second portion of this embodiment of the invention is a bracelet or pendant 10, shown in FIG. 2, to be worn by the user. The bracelet includes an RF antenna 11, an RF transceiver 12, one or more pushbuttons 13, a display 14, a vibrating alert 15 and an audio sounder 16. The pushbuttons direct an input to the RF transceiver 12 to initiate a predetermined signal to the RF transceiver 3 which causes a predetermined response from the microprocessor 5.

The operation of the invention is as follows:
1) A call is received on phone line 1. Part of the incoming ring signal contains the caller ID information, which identifies the calling party.
2) The caller ID information is decoded by the Caller ID receiver 4 and passed to the microprocessor 5.
3) The microprocessor may or may not compare the Caller ID number with an internal database to match it with a name.
4) The microprocessor and associated memory 5 generates an information packet and sends it to the RF transceiver 3.
3. The transceiver 3 sends an RF message through its antenna 7.
5) The signal is received by the antenna 11 of bracelet 10 and passed to the RF transceiver 12 of the bracelet 10.
6) The information is displayed on the display 14. In addition, the audible alert 16 and the vibrating alert 15 is activated.
7) The user will sense the vibration and hear the tone. He or she will look at the display 14 to see who is calling. He or she may choose not to try to answer the call based on this information.
8) If the user needs additional time to get to a phone, he or she may press one of the pushbuttons 13 on the bracelet 10. The transceiver 12 will generate a message and send it out using antenna 11.
9) The message is received at antenna 7 and passed to transceiver 3 and microprocessor 5.
10) The microprocessor will make a decision, based on predetermined criteria, on whether to:
   A) Answer the call and output a message indicating that the user is on the way or
   B) Answer the call and activate a speakerphone function using speaker 8 and microphone 9.

The above description of a two-way wireless system is preferable because of the advantages offered to the user. Although the preferred embodiment employs a transceiver both on the bracelet or pendant as well as the security panel it will be understood the lower-cost embodiments may merely utilize a transmitter at the security panel and a receiver at the bracelet.

For the sake of simplicity that term “bracelet” as used herein will be understood to include anklets, pendants and like. The invention has application to phones that are wired. As used herein the term “wired phone” include so-called land lines that are directly connected to a telephone system by wires including so-called “cordless” phones that have a base unit that is also directly connected to a telephone system by wires.

Although the term “security control panel 2” has been used in the description herein, those skilled in the art will recognize that the physical form of this component need not be panel mounted and that it can be very compact.

The respective methods and systems in accordance with the present system may utilize a computer that includes a microprocessor and memory and which cooperates with software that is commercially available or within the skill of practitioners in the programming arts.

It will be obvious to those having skill in the art that many changes may be made to the details of the above-described embodiment of this invention without departing from the underlying principles thereof. Accordingly, it will be appreciated that this invention is also applicable to other systems. The scope of this invention should, therefore, be determined only by the following claims.

1. A system to assist the user of a wired phone which comprises:
a security panel that includes means for connection to an associated phone line, a caller ID receiver and an RF transmitter, said caller ID receiver cooperating with the associated phone line and said RF transmitter cooperating with said caller ID receiver to transmit caller ID information, and
a bracelet to be worn by an associated user that includes an RF receiver, said RF receiver cooperating with said RF transmitter to access information provided by said RF transmitter, said bracelet further including a display cooperating with said RF receiver to indicate to the user information regarding an incoming call on the associated phone line.

2. A system in accordance with claim 1 wherein said RF transmitter is a transceiver.

3. A system in accordance with claim 1 wherein said RF transmitter and said RF receiver are both transceivers.

4. A system in accordance with claim 1 wherein said bracelet further includes a vibrating alert cooperating with said RF receiver to produce a vibration stimulus when said RF receiver receives a signal from said RF transmitter.

5. A system in accordance with claim 1 wherein said security panel further includes an audio amplifier.

6. A system in accordance with claim 5 wherein said security panel further includes a speaker coupled to said audio amplifier.

7. A system in accordance with claim 2 wherein said security panel further includes a microprocessor.

8. A system in accordance with claim 2 wherein said microprocessor formats messages to the RF transceiver.

9. A system in accordance with claim 3 wherein said security panel further includes a microprocessor.

10. A system in accordance with claim 3 wherein said microprocessor formats messages to the RF transceiver.

11. A system in accordance with claim 10 wherein said bracelet further includes at least one pushbutton cooperating with said RF transceiver in said bracelet to produce a predetermined output from said RF transceiver in said bracelet, said output of said RF transceiver in said bracelet cooperating with said RF transceiver in said security panel to produce a predetermined output to said microprocessor.

12. A system in accordance with claim 11 wherein said predetermined output to said microprocessor causes the associated phone line to go off hook.

13. A system in accordance with claim 12 wherein said predetermined output to said microprocessor causes the associated phone line to go off hook and a predetermined message to be delivered to an individual placing an incoming call.

14. A system in accordance with claim 13 wherein said security panel further includes an audio amplifier.

15. A system in accordance with claim 14 wherein said predetermined output to said microprocessor causes the activation of said audio amplifier.

16. A system in accordance with claim 11 wherein said bracelet further includes at least a second pushbutton cooperating with said RF transceiver in said bracelet to produce a second predetermined output from said RF transceiver in said bracelet, said output of said RF transceiver in said bracelet cooperating with said RF transceiver in said security panel to produce a second predetermined output to said microprocessor.

17. A system in accordance with claim 16 wherein said second predetermined output to said microprocessor initiates a message to an incoming caller that the user will answer the call shortly.

18. A system in accordance with claim 1 wherein said caller ID receiver includes a caller ID receiver circuit.

19. A system in accordance with claim 10 wherein said microprocessor formats a predetermined voice message that is audible to a caller making an incoming call to the security panel.

20. A system in accordance with claim 19 wherein the predetermined voice message that is audible to a caller making an incoming call to the security panel is a message that the end-user of the system needs additional time to reach the phone.

21. A system to assist the user of a wired phone which comprises:
means for connection to an associated phone line, a caller ID receiver and an RF transmitter, said caller ID receiver cooperating with the associated phone line and said first RF transceiver cooperating with said caller ID receiver to transmit caller ID information, and
a bracelet to be worn by an associated user that includes an RF receiver, said RF receiver cooperating with said RF transceiver to access information provided by said RF transmitter, said bracelet further including a display cooperating with said RF receiver to indicate to the user information regarding an incoming call on the associated phone line.

22. A system in accordance with claim 21 wherein said RF transmitter is a transceiver.

23. A system in accordance with claim 21 wherein said RF transmitter and said RF receiver are both transceivers.

24. A system in accordance with claim 21 wherein said bracelet further includes a vibrating alert cooperating with said RF receiver to produce a vibration stimulus when said RF receiver receives a signal from said RF transmitter.

25. A system in accordance with claim 21 wherein said system further includes an audio amplifier.

26. A system in accordance with claim 25 wherein said security panel further includes a speaker coupled to said audio amplifier.

27. A system in accordance with claim 22 wherein said security panel further includes a microprocessor.

28. A system in accordance with claim 22 wherein said microprocessor formats messages to the RF transceiver.

29. A system in accordance with claim 23 wherein said security panel further includes a microprocessor.

30. A system in accordance with claim 23 wherein said microprocessor formats messages to the RF transceiver.

31. A system in accordance with claim 30 wherein said bracelet further includes at least one pushbutton cooperating with said RF transceiver in said bracelet to produce a predetermined output from said RF transceiver in said bracelet, said output of said RF transceiver in said bracelet cooperating with said RF transceiver in said security panel to produce a predetermined output to said microprocessor.

32. A system in accordance with claim 31 wherein said predetermined output to said microprocessor causes the associated phone line to go off hook.

33. A system in accordance with claim 32 wherein said predetermined output to said microprocessor causes the associated phone line to go off hook and a predetermined message to be delivered to an individual placing an incoming call.

34. A system in accordance with claim 33 wherein said security panel further includes an audio amplifier.

35. A system in accordance with claim 34 wherein said predetermined output to said microprocessor causes the activation of said audio amplifier.

36. A system in accordance with claim 31 wherein said bracelet further includes at least a second pushbutton cooperating with said RF transceiver in said bracelet to produce a second predetermined output from said RF transceiver in said bracelet, said output of said RF transceiver in said bracelet cooperating with said RF transceiver in said security panel to produce a second predetermined output to said microprocessor.

37. A system in accordance with claim 36 wherein said second predetermined output to said microprocessor initiates a message to an incoming caller that the user will answer the call shortly.

38. A system in accordance with claim 21 wherein said caller ID receiver includes a caller ID receiver circuit.

39. A system in accordance with claim 30 wherein said microprocessor formats a predetermined voice message that is audible to a caller making an incoming call to the security panel.

40. A system in accordance with claim 39 wherein the predetermined voice message that is audible to a caller making an incoming call to the security panel is a message that the end-user of the system needs additional time to reach the phone.

41. A system to assist the user of a wired phone which comprises:
means for connection to an associated phone line, a caller ID receiver and a first RF transceiver, said caller ID receiver cooperating with the associated phone line and said first RF transceiver cooperating with said caller ID receiver to transmit caller ID information, and
a bracelet to be worn by an associated user that includes a second RF transceiver, said second RF transceiver cooperating with said first RF transceiver to access information provided by said first RF transceiver, said bracelet further including a display cooperating with said second RF transceiver to indicate to the user information regarding an incoming call on the associated phone line, said bracelet further includes a vibrating alert cooperating with said second RF transceiver to produce a vibration stimulus when said second RF transceiver receives a signal from said first RF transceiver.

42. A system to assist the user of a wired phone which comprises:
means for connection to an associated phone line that includes further includes an audio amplifier and speaker as well as a microprocessor, a caller ID receiver and a first RF transceiver, said caller ID receiver cooperating with the associated phone line and said first RF transceiver cooperating with said caller ID receiver to transmit caller ID information, and
a bracelet to be worn by an associated user that includes a second RF transceiver, said second RF transceiver cooperating with said first RF transceiver to access information provided by said first RF transceiver, said bracelet further including a display cooperating with said second RF transceiver to indicate to the user information regarding an incoming call on the associated phone line, said bracelet further includes a vibrating alert cooperating with said second RF transceiver to produce a vibration stimulus when said second RF transceiver receives a signal from said first RF transceiver.

43. A system in accordance with claim 42 wherein said microprocessor formats messages to the RF transceiver.

44. A system in accordance with claim 42 wherein said bracelet further includes at least one pushbutton cooperating with said RF transceiver in said bracelet to produce a predetermined output from said RF transceiver in said bracelet, said output of said RF transceiver in said bracelet cooperating with said RF transceiver in said security panel to produce a predetermined output to said microprocessor.

45. A system in accordance with claim 44 wherein said predetermined output to said microprocessor causes the associated phone line to go off hook.

46. A system in accordance with claim 44 wherein said predetermined output to said microprocessor causes the associated phone line to go off hook and a predetermined message to be delivered to an individual placing an incoming call.

47. A system in accordance with claim 46 wherein said bracelet further includes at least a second pushbutton cooperating with said RF transceiver in said bracelet to produce a second predetermined output from said RF transceiver in said bracelet, said output of said RF transceiver in said bracelet cooperating with said RF transceiver in said security panel to produce a second predetermined output to said microprocessor.

48. A system in accordance with claim 45 wherein said second predetermined output to said microprocessor initiates a message to an incoming caller that the user will answer the call shortly.

49. A system in accordance with claim 40 wherein said caller ID receiver includes a caller ID receiver circuit.

50. A system in accordance with claim 47 wherein said microprocessor formats a predetermined voice message that is audible to a caller making an incoming call to the security panel.

51. A system in accordance with claim 19 wherein the predetermined voice message that is audible to a caller making an incoming call is a message that the end-user of the system needs additional time to reach the phone.

52. A method to assist the user of a wired phone which comprises:
connecting to an associated phone line, providing apparatus that includes a caller ID receiver and an RF transmitter, and the providing step includes providing apparatus with a caller ID receiver cooperating with the phone line and said step of providing apparatus that includes an RF transmitter includes providing an RF transmitter that cooperates with the caller ID receiver to transmit caller ID information; and
the method further includes the step of providing a bracelet to be worn by an associated user that includes an RF receiver, the providing step includes providing an RF receiver that cooperates With the RF transmitter, accessing information provided by the RF transmitter, displaying to a user information regarding an incoming call on the associated phone line.

53. A method in accordance with claim 52 wherein the step of providing an RF transmitter includes providing a transceiver.

54. A method in accordance with claim 53 wherein the step of providing an RF transmitter and specifically providing an RF receiver that includes providing first and second RF transceivers.

55. A method in accordance with claim 53 wherein the method further includes producing a vibration stimulus when the RF receiver receives a signal from the RF transmitter.

56. A method in accordance with claim 53 wherein the providing step further includes providing an audio amplifier.

57. A method in accordance with claim 53 wherein the providing step further includes a speaker coupled to the audio amplifier.

58. A method in accordance with claim 53 wherein said providing step further includes providing a microprocessor.

59. A method in accordance with claim 54 wherein the method includes providing a microprocessor and formatting messages from the RF transceiver using the microprocessor.
